(19) United States
(12) Patent Application Publication
(10) Pub. No.: US 2025/0238930 A1
(43) Pub. Date: Jul. 24, 2025

(54) AORTIC ARCH SEGMENTATION AND ANALYSIS

(71) Applicant: The Board of Trustees of the University of Illinois, Urbana, IL (US)

(72) Inventors: Matthew Bramlet, Peoria, IL (US); Bradley P. Sutton, Savoy, IL (US)

(21) Appl. No.: 19/035,560

(22) Filed: Jan. 23, 2025

Related U.S. Application Data
(60) Provisional application No. 63/624,702, filed on Jan. 24, 2024.

(51) Int. Cl. G06T 7/11; G06T 7/00

(52) U.S. Cl. CPC G06T 7/11; G06T 7/0012; G06T 2207/10088; G06T 2207/20081

(57) ABSTRACT

An anatomy of interest, such as the aortic arch, is automatically segmented from magnetic resonance imaging (MRI) data. The segmented anatomy volume is then processed to track or otherwise determine a centerline of the anatomy volume. Based on this centerline, quantitative measures of the anatomy of interest can be computed. The resulting segmented anatomy volume, centerline, and/or quantitative measures can then be displayed to a user or stored for later use and/or processing. The segmented anatomy volume, centerline tracking and quantitative measures can be monitored to determine longitudinal deformations in the subject relative to previous measures from the subject, or relative to normative measures from an age-matched, sex-matched, race-matched, and/or disease-matched cohort.

### CROSS-REFERENCE TO RELATED APPLICATIONS

This application claims the benefit of U.S. Provisional Patent Application Ser. No. 63/624,702, filed on Jan. 24, 2024, and entitled “AORTIC ARCH SEGMENTATION AND ANALYSIS,” which is herein incorporated by reference in its entirety.

### BACKGROUND

For all types of aortic aneurysm, longitudinal surveillance of aneurysm dimension remains the primary metric for medical decision making. Cardiac MR imaging (CMR) is the preferred method for longitudinal surveillance due to its ability to generate diagnostic resolution 3D datasets allowing for multi-planar analysis while avoiding repeated exposure to radiation. However, each individual patient exhibits a unique aortic and aneurysm architecture which may differ significantly from expected population means. Given that the primary metric for deciding on surgery is patient specific longitudinal surveillance analyzed against standardized recommendations, there is a need to transition from 2D slice by slice analysis to automated 3D aorta analysis.

### SUMMARY OF THE DISCLOSURE

It is an aspect of the present disclosure to provide a method for automated segmentation and analysis of an anatomy of interest from magnetic resonance image data. The method includes accessing magnetic resonance image data with a computer system, where the magnetic resonance image data include magnetic resonance images acquired from a subject using a magnetic resonance imaging (MRI) system. Segmented anatomy volume data are generated from the magnetic resonance image data using the computer system. The segmented anatomy volume data include a three-dimensional (3D) volume of an anatomy of interest that is segmented from the magnetic resonance image data. Centerline tracking data are generated from the segmented anatomy volume data using the computer system, where the centerline tracking data include a centerline of the 3D volume of the anatomy of interest. Quantitative measures of the anatomy of interest are then generated based on the segmented anatomy volume data and the centerline tracking data. At least one of the segmented anatomy volume data, the centerline tracking data, or the quantitative measures are then output using the computer system.

It is another aspect of the present disclosure to provide a method for analysis of a segmented anatomy of interest generated from magnetic resonance image data. The method includes accessing segmented anatomy volume data with a computer system, where the segmented anatomy volume data comprise a segmented volume of an aortic arch of a subject. Centerline tracking data are generated by selecting a starting point in the segmented anatomy volume data and iteratively tracking a line from the starting point to a series of next points to define a centerline of the segmented anatomy volume. Each point in the series of next points is determined by moving a predetermined distance along the segmented anatomy volume; searching for an updated plane using a wobble function to apply inclination angles to the plane to find the updated plane as an angled plane with minimum cross-sectional area; determining a center-of-mass of the updated plane; and setting the center-of-mass of the updated plane as the next point in the series. Quantitative measures of the aortic arch are then generated based on the segmented anatomy volume data and the centerline tracking data, and the quantitative measures are output with the computer system.

### BRIEF DESCRIPTION OF THE DRAWINGS

FIG. 1 is a flowchart of an example method for automated segmentation and analysis of an anatomy of interest, such as the aortic arch, from magnetic resonance image data.

FIG. 2A is a 2D representation of a 3D model of the aortic arch with a marker at a location of cross-sectional measurement.

FIG. 2B is a graph of aortic diameter from diaphragm to root measured from the 3D model of the aortic arch in FIG. 2A.

FIG. 2C is a mask of cross-sectional area measured by automated processes described in the present disclosure.

FIG. 2D is an example clinical reference image.

FIG. 2E is a plot of the ascending aorta correlation between automated and clinical measures on 30 patients from an example study.

FIG. 3 is a flowchart of an example machine learning-based method for segmenting an anatomy of interest, such as the aortic arch, from magnetic resonance images.

FIG. 4 is a flowchart of an example method for training a machine learning model to segment anatomy from magnetic resonance images.

FIG. 5 is a block diagram of an example automated anatomy segmentation and analysis system according to some embodiments described in the present disclosure.

FIG. 6 is a block diagram of example components that can implement the system of FIG. 5.

FIG. 7 is a block diagram of an example magnetic resonance imaging (MRI) system that can be implemented to acquire magnetic resonance images in accordance with some embodiments described in the present disclosure.

### DETAILED DESCRIPTION

Described here are systems and methods for the automated segmentation and analysis of the aorta, other blood vessels, or other tubular anatomical structures or organs. In general, the anatomy of interest is automatically segmented from magnetic resonance imaging (MRI) data. The segmented anatomy volume is then processed to track or otherwise determine a centerline of the anatomy volume. Based on this centerline, quantitative measures of the anatomy of interest can be computed. The resulting segmented anatomy volume, centerline, and/or quantitative measures can then be displayed to a user or stored for later use and/or processing.

In a non-limiting example, the disclosed systems and methods automate three-dimensional (3D) segmentation of the aortic arch, or other vessel or anatomical structure, from magnetic resonance images, such as images acquired with a non-contrast 3D SSFP MRI imaging pulse sequence. Each slice of the segmented 3D anatomy is then analyzed to generate cross-sectional dimensions or other quantitative measures of anatomy geometry based on a computational centerline of the segmented volume. Advantageously, the disclosed systems and methods can be used to identify quantitative measures of aortic arch geometry, such as the aortic arch diameter at a number (e.g., nine, twelve) different clinically-relevant locations. This significantly decreases time-to-diagnosis, increases the accuracy and repeatability of measurements, and can assist clinicians in determining optimal time for surgery for patients with congenital heart conditions. Population-specific metrics can also be determined, such as those associated with patient age, race, sex, and other characteristics.

Advantageously, the disclosed systems and methods can be used to generate segmental 3D models representing the variance between an individual and an averaged normal or other baseline. Such a 3D model of these differences creates unique identifiers of specific pathologic conditions. In this way, the 3D variance model will represent reproducible characteristics according to pathologic condition.

It is an aspect of the present disclosure to provide for standardization through automation of clinically relevant aortic arch measurements. As another advantage, cohort specific z-scores of aneurysm populations can be generated. In still other aspects, the disclosed systems and methods can provide for the automation of machine learned patterns of diagnostic categories based on 3D variance models.

Certain embodiments of the present disclosure enable fully automated monitoring of aneurysms, establishment of population averages, and/or creation of tools that leverage standardized 3D formats to ensure clinically verifiable creation of patient-specific models.

Certain embodiments of the present disclosure automatically segment the aortic arch or other anatomical structures in 3D, track the centerline of the segmented anatomy, make clinical diagnostic measures from the determined centerline, and/or generate heat maps showing longitudinal changes in a patient and/or differences between a patient and their appropriate age-, sex-, race-, and disease-matched normative aortic arch.

Normative values can be extracted from available historic clinical data, which can include congenital cardiac patients who underwent cardiac MRI (CMR) for evaluation of aortic dimensions. Performance of the automated tool can be assessed through intraclass correlations with manually measured data on a subset of the historical clinical data. Certain embodiments of the present disclosure enable automated, objective evaluations of the aortic arch or other anatomic structures, placed into the appropriate context. In addition, certain embodiments can enable detailed visualizations of differences in the current patient's arch anatomy to provide improved understanding of the changes to the arch or its differences from expected anatomy. These visualizations can be provided both in standard image formats and in virtual reality enabled formats for surgical planning.

Certain embodiments of the present disclosure provide a tool to automate the generation and quantitative analysis of 3D representations of anatomy (e.g., the aortic arch, other blood vessels, other tubular organs or anatomical structures, etc.), allowing for expedited formation of informative normative measures, improved visualizations of deviations from normal, and improvement in the value of the diagnostic information received from this data compared to current manual clinical processes and machine learning (ML)-assisted efforts. Certain embodiments of the present disclosure enable fully automated monitoring of aneurysms, establishment of population averages, and tools that leverage standardized 3D formats to ensure clinical auditable results.

Certain embodiments provide a framework for clinical diagnostic work-up of the aortic arch, including: automated segmentation that extracts the aortic arch from CMR data and performs centerline tracking and cross-sectional diameter estimation, along with the creation of actionable 3D assets for intervention planning in a virtual reality (VR), augmented reality (AR), and/or extended reality (XR) environment. Certain embodiments leverage standardized 3D formats to hold 3D objects together with DICOM positioning data to enable segmentations to be aligned to original imaging data for verification of results and to address clinical confidence.

Using both manual clinical measures and the automated analysis resulting from the above, atlasing can be implemented to label different domains of the aortic arch, or other segmented anatomy volume. Normative measures of the aortic arch, or other segmented anatomy volume, can be examined across different populations including age, sex, race, and diagnosis. Historical data can be examined to monitor disease progression measures to track severity in diverse populations. Additionally or alternatively, levels of quantitative measures that can be used as cut-offs for surgical intervention can also be determined.

Certain embodiments also include a visualization tool to display the segmented aortic arch, or other anatomy, along with a heat map that indicates regions where there are significant size changes longitudinally in the same patient and/or indicates deviations from expected, normative measures. This display can be created automatically in both DICOM and VR/AR/XR to enable the clinician to view the 3D anatomy and verify the location of pathology.

Certain embodiments provide a reproducible, accurate, and quantitative clinical tool that can leverage the 3D aortic arch or other segmented anatomy volume to perform precise, consistent clinical measurements automatically. Further, it can produce actionable 3D objects in a VR, AR, and/or XR environment that are suitable for planning surgical interventions.

Certain embodiments of the present disclosure include systems and methods that automate segmentation of 3D aortas, or other anatomical structures, and perform extraction of clinical measures, and can create fast and reliable measurements of aortic arch anatomy or other segmented anatomy volumes. Rather than relying on a machine to evaluate a large number of 2D images to define the aorta and generate aortic diameters, certain embodiments focus on patient-specific 3D models of anatomy. Certain embodiments include automating segmentation of non-contrast MRI images into 3D models of patient-specific aortas, or other anatomical structures, and once the 3D model is generated: applying mathematical constructs to elucidate clinically relevant variables to compare to cohort-specific standards.

Certain embodiments can impact clinical care of aortic aneurysms through improved reproducibility of dimensional measurements, improved longitudinal surveillance reliability, and improved standardization of syndromic aorta normative values. With institutions focusing on generation of strong non-contrast CMR datasets, embodiments of the segmentation and analysis tool will be able to negate variations between institutions and inter- and intra-observer variabilities. Success of this automated tool will have a significant impact on disadvantaged and remote populations that lack access to quaternary center expertise.

Certain embodiments of the present disclosure extend beyond standardized 2D measurements by evaluating the pathologic change from a 3D model perspective. By analyzing the dimensional changes on a voxel-by-voxel basis of an entire 3D object, certain embodiments can capture less obvious regions of vessel wall weakness or other anatomical changes than standard 2D slice analysis.

Certain embodiments of an automated 3D segmentation and analytics tool can open up the opportunity to generate new knowledge in these varied cohorts (i.e. bicuspid aortic valve, EDS, congenital heart disease); that would otherwise be deemed unattainable due to the varied number of cohorts and the many hours of manual measurements required across various institutions and scanning techniques to attain numbers that would be considered valid for universal recommendations.

Certain embodiments can enable multi-institutional generation of normative data for diagnoses such as Turner Syndrome, tetralogy of Fallot, T-DGA s/p ASO with LeCompte, EDS, among many others. The large-scale analysis would also allow for gender and indexed values to be considered in the normative datasets. Improved normative values for these cohorts will allow for improved medical decision making for the individual patient against their own cohort's normative values. Given the significant morbidity risk associated with aortoplasty and the significant mortality risk of dissection, this data will provide the clinical practitioner with new confidence in determining the proper cut-off for sending a patient to the OR.

Certain embodiments include a fully automated pipeline tool that can transform non-contrast CMR scans, or other MRI data, into actionable 3D objects suitable for reliable, automated diagnostics and visualization for longitudinal and comparative diagnostics of the aortic arch or other segmented anatomy volume. Certain embodiments include a software tool to automate segmentation and analysis of the aorta from 3D SSFP non-contrast MRI data. Certain embodiments include atlas-based labeling of regions of the aorta and clinical validation of automated measurement tool.

Certain embodiments include 3D heat map models that provide of the visualization of deformations between the normative models and patient specific models, leveraging this to identify 3D patterns of pathology. By way of example, a normative model can be generated for a cohort, such as an age-matched cohort, a sex-matched cohort, a race-matched cohort, etc. Additionally or alternatively, the cohort can be matched based on more than one criteria, such as an cohort that is matched on both age and sex, both sex and race, etc. The segmented anatomy volume generated for a subject can be overlaid on, or otherwise compared with, the normative model to generate a heat map of variance that represents differences throughout the aorta (or other segmented anatomy). These variances can represent the small differences in size of the specific subject compared to the average depicted in the normative model. When the subject has a pathological condition that affects the structure of the anatomy, the pathological feature will exhibit a greater degree of deformation or variance relative to the normative model. These “hot spots” in the heat map can be used to readily identify regions of significant change relative to the baseline depicted in the normative model. In certain embodiments, these hot spots can be exported or otherwise extracted from the heat map and used to generate a library of pathological conditions that can be used to training machine learning models or other automated diagnosis tasks.

In an example embodiment, a software pipeline for clinical diagnostic work-up of the aortic arch, from diaphragm to root, includes: automated segmentation that extracts the aortic arch from CMR data and performs centerline tracking, cross-sectional diameter estimation, along with the creation of actionable 3D assets for intervention planning in virtual reality (VR). The example embodiment can leverage standardized 3D formats to hold the patient-specific 3D model together with DICOM positioning data to allow for segmentations to be aligned to original imaging data for verification of results to address clinical confidence. This automation can form the basis for both patient-specific longitudinal analysis as well as bulk cohort analysis. As described above, the example embodiment may include two separate software tools: automated segmentation and automated centerline tracking for diagnostic measures.

In some aspects of the present disclosure, a 3D automatic segmentation on magnetic resonance image data to provide a 3D segmented volume of an anatomy of interest is provided. As a non-limiting example, the magnetic resonance image data may be non-contrast CMR data and the 3D segmented anatomy volume may be a 3D segmented aortic arch. The input to the segmentation can be the magnetic resonance image data in a DICOM data format. The magnetic resonance image data can be acquired using a non-contrast 3D SSFP pulse sequence, or other suitable pulse sequence. The output of the segmentation can be a 3D model of the segmented anatomy, such as the aortic arch, in an STL or other suitable data format, which can be suitable for VR/AR/XR visualization. In certain implementations, the output of the segmentation can also include a standardized data format placing the segmentation back into the DICOM data to enable clinical auditing of the segmentation. Traditional machine learning methods generate output images in conventional formats, such as JPEG image formats. The problem with outputting images in conventional formats like this is that derived measurements cannot be related back to the original DICOM dataset, which means the automated results cannot be overlaid on the source DICOM data for quality control. Thus, in certain embodiments, the coordinates of the original DICOM input are maintained throughout the process so that the results can be displayed into standard medical imaging formats. This allows the clinical diagnostician to review and confirm the results in an FDA approved application.

With a 3D model of the aorta or other anatomy of interest, the next step is to generate diagnostic measures along the segmented anatomy volume (e.g., the aortic arch). This involves identification of the centerline of the segmented anatomy volume along with basic image processing steps to adjust the centerline to ensure that it is perpendicular to the main axis of segmented anatomy volume.

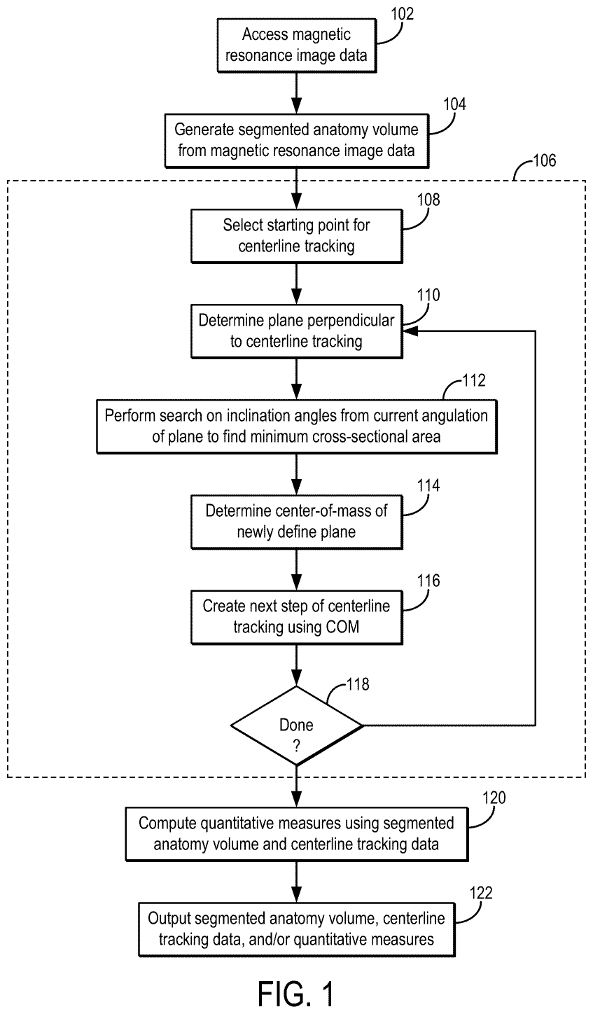

Referring now to FIG. 1, a flowchart is illustrated as setting forth the steps of an example method for automated segmentation and analysis of an anatomy of interest, such as the aortic arch, in a subject.

The method includes accessing magnetic resonance image data with a computer system, as indicated at step 102. Accessing the magnetic resonance image data may include retrieving such data from a memory or other suitable data storage device or medium. Additionally or alternatively, accessing the magnetic resonance image data may include acquiring such data with an MRI and transferring or otherwise communicating the data to the computer system, which may be a part of the MRI system.

The magnetic resonance image data may include images acquired from a subject using an MRI system. As a non-limiting example, the images may be non-contrast-enhanced images acquired using a suitable pulse sequence, such as a non-contrast 3D SSFP pulse sequence. In other embodiments, different pulse sequences may be used to acquire images with different contrast weightings, such as T1-weighting, T2-weighting, proton density weighting, diffusion weighting, perfusion weighting, susceptibility weighting, and so on.

The magnetic resonance image data are then processed to generate a segmented anatomy volume, as indicated at step 104. The segmented anatomy volume includes a 3D volume or model of anatomy of interest that has been segmented from the magnetic resonance image data. As a non-limiting example, the segmented anatomy volume may include a segmented volume corresponding to the aortic arch of the subject.

In general, the segmented anatomy volume can be generated by accessing a trained machine learning model that has been trained on training data to segment magnetic resonance images, and inputting the magnetic resonance image data to the machine learning model to generate the segmented anatomy volume as an output.

The development of machine learning and deep learning image segmentation algorithms for medical imaging is becoming more and more pervasive across disciplines due to the availability of large data sets and tools that enable efficient handling and processing of medical imaging data. In one example implementation, a deep learning software package (such as TorchIO) can be utilized. As one non-limiting example, the deep learning segmentation model can be implemented using a U-Net architecture. For training, manually segmented cases can be used. Additionally, improvement in performance of segmentation can be achieved through bias field correction of the images followed by using a bounding box to restrict segmentation to just the area of interest. The bounding box can be determined by taking one patient image (e.g., a healthy control for the aortic arch) as a template and drawing reference masks on top of that template image. As a non-limiting example, an Advanced Normalization Tools (ANTS, http://stnava.github.io/ANTs/) framework can be used to perform diffeomorphic mapping between every new patient in the database and this target patient. The mapping can then be inverse transformed and applied to the mask, with nearest neighbor interpolation to keep the binary nature of the bounding box mask. Application of the bounding box restricts all further processing steps to just the region of the image encompassing the aortic arch, or other anatomy to be segmented, drastically simplifying the problem and making the segmentation less reliant on specific parameters like field-of-view or imaging placement.

Current approaches to creating segmented 3D objects from medical images lack standardization to enable widespread and systematic incorporation into clinical diagnostic pipelines. While algorithms have been developed to produce highly accurate segmentations, the results lack the ability to be transformed back into the original images, a process that can be referred to as clinical auditing or model verification. Clinical auditing is important in the successful translation of diagnostic tools from human to machine centric. Certain embodiments of the present disclosure leverage recent additions to the DICOM standard to incorporate 3D objects, and provide a new data format to enable easy overlay of segmentations with DICOM viewing tools in the clinic. In certain implementations, a derived image data type can be generated in the space of the original DICOM that contains the object mask.

Centerline tracking data of the segmented anatomy volume are then generated, as indicated at process block 106. In general, the centerline tracking data can include an estimate of the centerline of the segmented anatomy volume, in addition to perpendicular planes at one or more locations along the centerline.

Certain embodiments include an algorithm for tracking the centerline and making maximum diameter measures at various points along the segmented anatomy volume. As a non-limiting example, the centerline tracking data can be generated by first selecting a starting point in the segmented anatomy volume for the centerline tracking, as indicated at step 108. As a non-limiting example, the starting point can be selected as the inferior point of the segmented anatomy volume (e.g., the aortic arch where it passes through the diaphragm). The centerline can then be tracked from this starting point as follows.

First, a plane perpendicular to the line that is being tracked is identified to form an initial cross-sectional image, as indicated at step 110. A search is then performed on slight inclinations in angles from the current angulation of the plane to find the minimum cross-sectional area, as indicated at step 112. These slight inclinations in angles can be applied using a wobble function or schedule of angles to provide the wobbling of the plane used to determine the minimum cross-sectional area. This wobble function is advantageously designed to “walk up” the segmented anatomy volume, such as the candy cane-like shape of the aorta. Advantageously, using the wobble function helps keep the cross-sectional planes perpendicular to the centerline.

In general, the wobble function is used to evaluate various cross-sectional areas through a center point on the aortic tube. By recording each area of the various wobble inclinations, the minimal cross sectional area relates to the most perpendicular plane in the main two perpendicular axes of a tube.

In the example of segmenting the aortic arch, due to the aorta giving off other vessels, the wobble around a point in the segmented anatomy volume may sometimes track out a head and neck vessel rather than making the run around the aortic arch. To address these potential scenarios, the 3D segmented anatomy volume can be eroded down to a smaller diameter that eliminates the smaller head and neck vessels. As a result, the ability of the centerline tracking to trace around the aortic arch is significantly improved.

Additionally, the wobble may sometimes run into problems in the aortic root which has three sinuses like a 3D three-leaf clover. In some instances, the wobble may capture the cave opening of one of these clover leaves and shift the vector to exit out the leaf rather than through the aortic annulus into the left ventricle. To address these potential scenarios, the centerline derived from the eroded segmented anatomy volume have a polynomial function applied to it in order to try and smooth out the curves in a 3D space. This approach can significantly improve the ability of the centerline tracking to have the centerline exit the root in the correct location. With this new centerline, a more restrictive wobble can then be applied to get the minimal cross-sectional area of the non-eroded aorta.

With the newly defined plane (i.e., the plane with the minimal cross-sectional area), the center-of-mass (COM) of the segmented anatomy volume mask at the newly defined plane is determined, as indicated at step 114. This COM point is the location of the centerline at this step of the segmented anatomy volume. With the new angulation and new COM point, the next step along the segmented anatomy volume is created at step 116 and the process repeats back to the first step of identifying a perpendicular plane at step 110 until a stopping criterion is reached as determined at decision block 118. By way of example, the next step along the segmented anatomy volume can be determined by taking a vector perpendicular to the plane with the minimal cross-section area and using that normal vector to select the next center point around which to use the wobble function to determine the next cross-sectional plane.

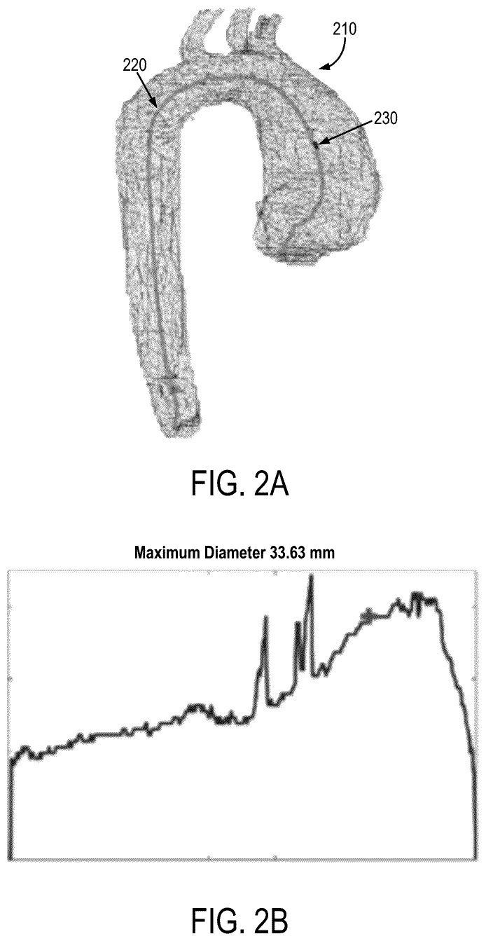

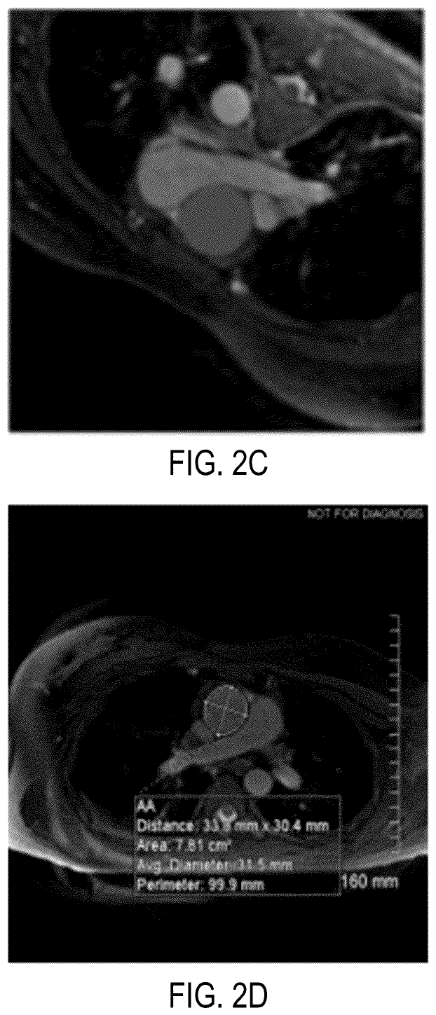

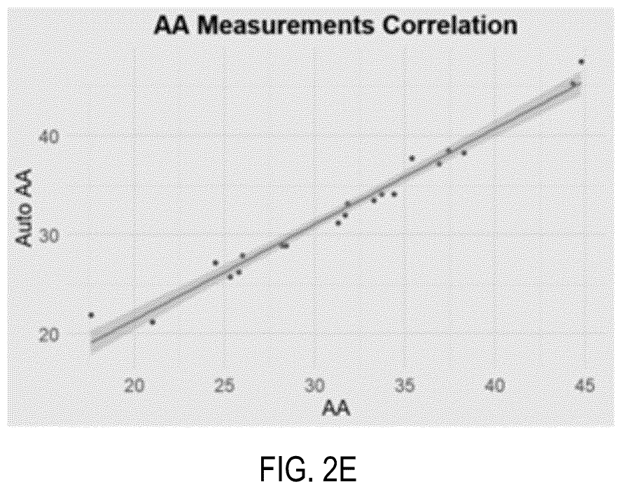

This process tracks the aortic arch centerline well, as shown in FIGS. 2A-2C. FIG. 2A depicts a segmented anatomy volume 210 that constitutes a 3D model of an aortic arch together with a centerline tracking 220 through that segmented anatomy volume 210. A point 230 selected on the centerline tracking is indicated in the visualization of the segmented anatomy volume 210. FIG. 2B shows a graph of aortic diameter measured from the diaphragm to the aortic root, and FIG. 2C shows an example mask of cross-sectional area measured by the process described in the present disclosure.

Using the segmented anatomy volume and the centerline tracking data, one or more quantitative measures of the segmented anatomy are then determined, as indicated at step 120. For instance, with the centerline tracked, diagnostic measurements at the particular locations of clinical interest, identified by normalization of a template segmented anatomy volume to the current patient under consideration, can be performed. At each of these locations, the plane perpendicular to the centerline is identified and a measurement of the maximum diameter of the cross-section of the segmented anatomy volume is performed. In some implementations, the calculation of these quantitative measures can be performed concurrently with step 110 at each step of centerline tracking to avoid resampling the 3D image again.

Certain embodiments of the present disclosure utilize both manual clinical measures and the automated analysis resulting from above to add atlasing to label different domains of the aortic arch or other segmented anatomy volume to the software pipeline. Normative measures of the aortic arch or other segmented anatomy volume can be monitored across different populations including age, sex, race, and diagnosis. Historical data and disease progression measures can be examined to track severity in diverse populations and to determine levels of quantitative measures that can be indicative of cut-off thresholds for surgical intervention.

Utilizing the automated pipeline and diffeomorphic registration, an atlas can be extracted for each subject at each of the clinically specified locations of the aortic arch or other segmented anatomy volume. The largest diameter can also be exported. These quantitative data can be used to determine the locations where manual measures differ from the automated measures and to characterize any systematic differences. A systematic difference could result from maximal diameter measures being made according to a particular viewing process, such as how the angulation is performed for identifying the correct plane manually. As a non-limiting example, historical data for aortic arch can include a database containing a combination of normal aortas and other cases representing: aortic valve disease, D-Transposition of the Great Arteries (D-TGA), Tetralogy of Fallot (TOF), and syndromic conditions. Such a robust database will allow for generation of aorta site-specific normative measures per cohort (also examining sex, age, and race in addition to clinical condition as a cohort). The resulting z-score data can be utilized to compare institutional data against published best practice cut-offs for surgical intervention.

In some implementations, the quantitative measures can be generated at a number of predetermined clinical locations, such as nine or twelve standard clinical locations within the aorta. In still other implementations, the methods described in the present disclosure are capable of outputting iterative stepwise output measurements throughout the entire aorta. As a non-limiting example, compared to nine measured locations in a clinical study, the methods described in the present disclosure can generate quantitative measurements at over 400 different locations along the segmented aorta (or other segmented anatomy), which can be displayed in a graph or other type of visual output.

The segmented anatomy volume, centerline tracking data, and/or quantitative measures are then output using the computer system, as indicated at step 122. Outputting these data can include presenting one or more of the data to a user via the computer system, other computing device, or other display device. In some other implementations, outputting the data can include generating build instructions for use with an additive manufacturing process to manufacture a physical model of the segmented anatomy volume. For instance, the data can be converted to an STL file format or other build instruction format, and the build instructions provided to an additive manufacturing system, such as a 3D printer, to manufacture a physical model of the segmented anatomy volume. Additionally or alternatively, outputting these data can include storing the data for later use or processing.

In some embodiments, outputting the data can include computing one or more heat maps, variation models, or the like, and outputting the one or more heat maps, variation models, or the like, via the computer system.

Certain embodiments of the present disclosure include a visualization tool to display the segmented aortic arch, or other segmented anatomy volume along with a heat map to indicate regions where there are significant size changes longitudinally in the same patient and/or deviations from expected, normative measures. This display can be created automatically in both DICOM and VR/AR/XR to enable the clinician to view the 3D anatomy and verify the location of pathology.

In an example embodiment, the proposed tool can provide diagnostic information that greatly exceeds the current manual clinical pathway, which only provides a few measurements at specific locations along the aortic arch or other segmented anatomy volume. In contrast, the automated tool provides those manual measures and, in addition, provides a full 3D model of the patient's aortic arch or other segmented anatomy volume. Additional quantifications and visualizations based on this 3D model can also be developed, including quantification and generation of a heat map showing variations from cohort norms as noted above. This can allow for automated diagnoses, identifying cases of geometric difference that fall outside of the specific manual measures. In addition, variations in anatomy within a patient over time can also be quantified and visualized, looking at longitudinal changes quantitatively all along the aortic arch or other segmented anatomy volume. Together these visualizations can help to identify early pathologic conditions or risks, such as early dissective risk.

These visualizations can be created by using a diffeomorphic mapping to warp the cohort-specific aortic arch (or other segmented anatomy volume) atlas or patient-specific previous time point to the current aortic arch (or other segmented anatomy volume) under consideration. In addition to warping the atlas image to the current patient, a map of deformations involved in that warp can be provided. By taking the square root of the sum of the deformations in all directions, a magnitude deformation map can be formed, where the magnitude deformation map shows where larger deformations are needed to match the template. This can also be shown with directionality of deformations as quiver (or arrow) plots.

Preventing fatal aortic dissection in many forms of congenital heart disease is a medical decision-making dilemma. Aortic aneurysm growth is monitored by clinicians and once a threshold in size is crossed, the patient must undergo complex aortoplasty which carries significant risk for stroke, paralysis or other significant morbidities or even death. Therefore, the decision to send a patient to surgery is not made lightly. In-hospital mortality for acute type-A dissection remains remarkably high at 22%. Of those patients with acute aortic dissection, 35% fit the cohort of Marfan syndrome, history of aortic aneurysm or prior cardiac surgery; all of which point to the prevalence of care within congenital cardiology. Estimates of financial impact are challenging, but a recent estimate of the annual German societal cost to care for patients with Marfan syndrome alone reached as high as €386.9 million.

Preventative strategies targeting mitigation of societal cost and maintenance of quality of life include pharmacologic therapy and longitudinal analysis of aneurysm dimensions for the purpose of prophylactic repair of aortic aneurysms. Yet, despite these measures, as the rate of aortic aneurysms have increased, so has the rate of surgical interventions for acute aortic syndromes; indicating the need for improved analysis of aortic aneurysm progression and prediction of dissection. The systems and methods described in the present disclosure facilitate monitoring which patients can benefit from surgical or other therapeutic interventions.

The gravity of the medical decision to take a healthy patient to the operating room (OR) and risk stroke, paralysis and even death to prevent a potential problem that carries a marginally higher risk of the same cannot be overstated. The decision to prophylactically operate is a patient-specific decision which can be based on longitudinal MRI surveillance of aortic diameters compared to cohort specific norms. Outside of Marfan syndrome, cohort norms are not well documented and longitudinal surveillance of the individual patient is only as good as the consistency by which it is measured. Certain embodiments of the present disclosure solve for this problem through an automated tool that can allow for automated aortic measurement from individual non-contrast MRI imaging, thereby giving the patient the benefit of consistency (especially those underserved patients that are being seen at non-quaternary centers) while also giving the radiology industry a simple tool by which to generate cohort-specific normative data for improved medical decision making within these cohorts.

Modernized, patient-specific longitudinal aneurysm measurements combined with cohort specific norms can provide the medical decision-making team with renewed confidence in choosing which patients to send to the OR for prophylactic treatment.

Given that medical decision making is based on aneurysm size as well as changes over time, reproducible and reliable longitudinal measurements of the entire aorta of the same patient will improve medical decision making. The aorta is an organic 3D object, and weaknesses in the vessel wall are unlikely to be linear; making efforts to compare measurements in the current clinical nine standard prescribed locations moot.

An example implementation of the centerline tracking algorithm was applied to 38 manually segmented CMR cases. The clinical measures and automated measures for one subject from this example are shown in FIGS. 2D and 2E. FIG. 2D shows an example clinical measurement and FIG. 2E shows correlation between automated and manual measures on 30 patients. There was excellent correlation between the automated measurement and the clinical measurement. The intra-class correlation coefficient (ICC) for each of the nine measured locations of the aorta were: sinus of Valsalva, 0.99; sino-tubular junction, 0.80; ascending aorta, 0.98; brachiocephalic artery, 0.99; transverse segment 1, 0.95; transverse segment 2, 0.96; isthmus region, 0.96; descending aorta, 0.96, aorta at diaphragm, 0.95.

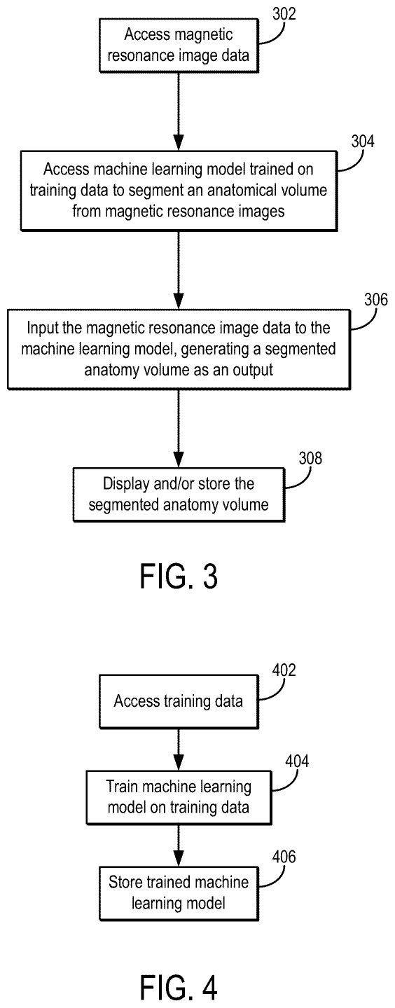

Referring now to FIG. 3, a flowchart is illustrated as setting forth the steps of an example method for generating classified feature data using a suitably trained neural network or other machine learning algorithm. As will be described, the neural network or other machine learning algorithm takes magnetic resonance image data as an input and generates segmented anatomy volume data as an output. As an example, the segmented anatomy volume data can be a 3D volume corresponding to a segmented anatomical structure, such as the aortic arch.

The method includes accessing magnetic resonance image data with a computer system, as indicated at step 302. Accessing the magnetic resonance image data may include retrieving such data from a memory or other suitable data storage device or medium. Additionally or alternatively, accessing the magnetic resonance image data may include acquiring such data with an MRI and transferring or otherwise communicating the data to the computer system, which may be a part of the MRI system. The magnetic resonance image data accessed in step 302 can be the same magnetic resonance image data already accessed with the computer system in step 102 of the method for automated segmentation and analysis illustrated in FIG. 1.

A trained neural network (or other suitable machine learning algorithm) is then accessed with the computer system, as indicated at step 304. In general, the neural network is trained, or has been trained, on training data in order to segment a 3D volume of an anatomical structure from magnetic resonance images (e.g., a series of 2D image slices, a 3D image volume).

Accessing the trained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs.

The magnetic resonance image data are then input to the one or more trained neural networks, generating output as segmented anatomy volume data, as indicated at step 306. As described above, the segmented anatomy volume data include a 3D volume or model of the anatomy segmented from the magnetic resonance image data. In some embodiments, the segmented anatomy volume data may be output or otherwise stored in an STL data format, or another data format suitable for 3D modelling and/or use in a VR, AR, and/or XR environment.

The segmented anatomy volume data generated by inputting the magnetic resonance image data to the trained neural network(s) can then be displayed to a user, stored for later use or further processing, or both, as indicated at step 308. As an example, the segmented anatomy volume data can be stored for additional use in the automated segmentation and analysis method illustrated in FIG. 1.

Referring now to FIG. 4, a flowchart is illustrated as setting forth the steps of an example method for training one or more neural networks (or other suitable machine learning algorithms) on training data, such that the one or more neural networks are trained to receive magnetic resonance image data as an input in order to generate segmented anatomy volume data as an output.

In general, the neural network(s) can implement any number of different neural network architectures. For instance, the neural network(s) could implement a convolutional neural network, a residual neural network, or the like. In one non-limiting example, the neural network may implement a U-Net architecture. Alternatively, the neural network(s) could be replaced with other suitable machine learning or artificial intelligence algorithms, such as those based on supervised learning, unsupervised learning, deep learning, ensemble learning, dimensionality reduction, and so on.

The method includes accessing training data with a computer system, as indicated at step 402. Accessing the training data may include retrieving such data from a memory or other suitable data storage device or medium. Alternatively, accessing the training data may include acquiring such data with an MRI system and transferring or otherwise communicating the data to the computer system.

In general, the training data can include magnetic resonance images and corresponding segmented images or image volumes. In some embodiments, the training data may include magnetic resonance images and/or segmented volumes that have been labeled (e.g., labeled as corresponding to different anatomical structures).

The method can include assembling training data from magnetic resonance images using a computer system. This step may include assembling the magnetic resonance images into an appropriate data structure on which the neural network or other machine learning algorithm can be trained. Assembling the training data may include assembling magnetic resonance images, segmented magnetic resonance images, and other relevant data. For instance, assembling the training data may include generating labeled data and including the labeled data in the training data. Labeled data may include magnetic resonance images, segmented magnetic resonance images, or other relevant data that have been labeled as belonging to, or otherwise being associated with, one or more different anatomical structures. For instance, labeled data may include segmented magnetic resonance images (e.g., segmented volumes) that have been labeled as being associated with an aortic arch.

In an example implementation, manually segmented data were leveraged as segmented data for use in a training dataset. Using data augmentation, as few as 60 datasets were sufficient for training heart segmentation due to the excellent contrast in the CMR images.

One or more neural networks (or other suitable machine learning algorithms) are trained on the training data, as indicated at step 404. In general, the neural network can be trained by optimizing network parameters (e.g., weights, biases, or both) based on minimizing a loss function. As one non-limiting example, the loss function may be a mean squared error loss function.

Training a neural network may include initializing the neural network, such as by computing, estimating, or otherwise selecting initial network parameters (e.g., weights, biases, or both). During training, an artificial neural network receives the inputs for a training example and generates an output using the bias for each node, and the connections between each node and the corresponding weights. For instance, training data can be input to the initialized neural network, generating output as segmented anatomy volume data. The artificial neural network then compares the generated output with the actual output of the training example in order to evaluate the quality of the segmented anatomy volume data. For instance, the segmented anatomy volume data can be passed to a loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current neural network and its associated network parameters represent the trained neural network. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, unsupervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

The one or more trained neural networks are then stored for later use, as indicated at step 406. Storing the neural network(s) may include storing network parameters (e.g., weights, biases, or both), which have been computed or otherwise estimated by training the neural network(s) on the training data. Storing the trained neural network(s) may also include storing the particular neural network architecture to be implemented. For instance, data pertaining to the layers in the neural network architecture (e.g., number of layers, type of layers, ordering of layers, connections between layers, hyperparameters for layers) may be stored.

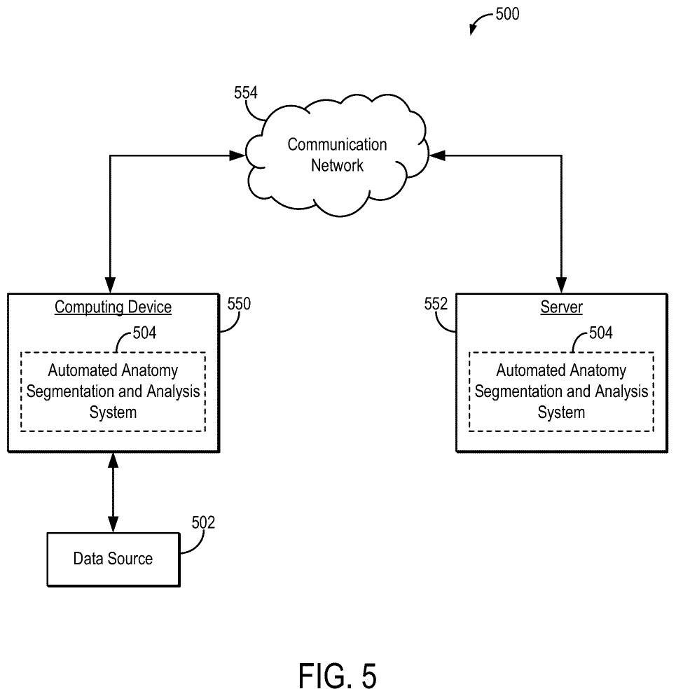

FIG. 5 shows an example of a system 500 for automated anatomy segmentation and analysis in accordance with some embodiments of the systems and methods described in the present disclosure is shown. As shown in FIG. 5, a computing device 550 can receive one or more types of data (e.g., magnetic resonance image data, segmented anatomy volume data) from data source 502. In some embodiments, computing device 550 can execute at least a portion of an automated anatomy segmentation and analysis system 504 to generate segmented anatomy volume data, centerline tracking data, and/or quantitative measures from data received from the data source 502.

Additionally or alternatively, in some embodiments, the computing device 550 can communicate information about data received from the data source 502 to a server 552 over a communication network 554, which can execute at least a portion of the automated anatomy segmentation and analysis system 504. In such embodiments, the server 552 can return information to the computing device 550 (and/or any other suitable computing device) indicative of an output of the automated anatomy segmentation and analysis system 504. As one non-limiting example, the server 552 may include a picture archiving and communication system (PACS). Advantageously, the methods described in the present disclosure can be implemented in the background of a PACS to automatically take each study, generate a 3D segmented anatomy volume, and generate automated quantitative measurements. Because this can be done at scale, thousands of studies can be partitioned into various cohorts based on criteria established by a user or at the institution level in a fully automated process. As a result, the ability to generate normative values can be automated.

In some embodiments, computing device 550 and/or server 552 can be any suitable computing device or combination of devices, such as a desktop computer, a laptop computer, a smartphone, a tablet computer, a wearable computer, a server computer, a virtual machine being executed by a physical computing device, and so on. The computing device 550 and/or server 552 can also reconstruct images from the data.

In some embodiments, data source 502 can be any suitable source of data (e.g., measurement data, images reconstructed from measurement data, processed image data), such as an MRI system, another computing device (e.g., a server storing measurement data, images reconstructed from measurement data, processed image data), and so on. In some embodiments, data source 502 can be local to computing device 550. For example, data source 502 can be incorporated with computing device 550 (e.g., computing device 550 can be configured as part of a device for measuring, recording, estimating, acquiring, or otherwise collecting or storing data). As another example, data source 502 can be connected to computing device 550 by a cable, a direct wireless link, and so on. Additionally or alternatively, in some embodiments, data source 502 can be located locally and/or remotely from computing device 550, and can communicate data to computing device 550 (and/or server 552) via a communication network (e.g., communication network 554).

In some embodiments, communication network 554 can be any suitable communication network or combination of communication networks. For example, communication network 554 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 554 can be a local area network, a wide area network, a public network (e.g., the Internet), a private or semi-private network (e.g., a corporate or university intranet), any other suitable type of network, or any suitable combination of networks. Communications links shown in FIG. 5 can each be any suitable communications link or combination of communications links, such as wired links, fiber optic links, Wi-Fi links, Bluetooth links, cellular links, and so on.

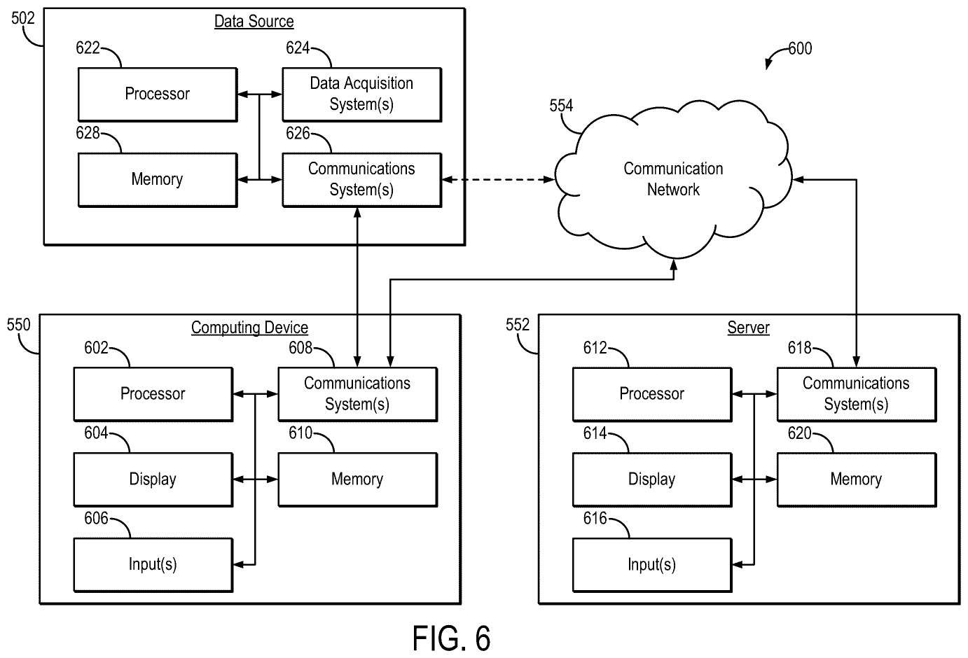

Referring now to FIG. 6, an example of hardware 600 that can be used to implement data source 502, computing device 550, and server 552 in accordance with some embodiments of the systems and methods described in the present disclosure is shown.

As shown in FIG. 6, in some embodiments, computing device 550 can include a processor 602, a display 604, one or more inputs 606, one or more communication systems 608, and/or memory 610. In some embodiments, processor 602 can be any suitable hardware processor or combination of processors, such as a central processing unit (“CPU”), a graphics processing unit (“GPU”), and so on. In some embodiments, display 604 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 606 can include any suitable input devices and/or sensors that can be used to receive user input, such as a keyboard, a mouse, a touchscreen, a microphone, and so on.

In some embodiments, communications systems 608 can include any suitable hardware, firmware, and/or software for communicating information over communication network 554 and/or any other suitable communication networks. For example, communications systems 608 can include one or more transceivers, one or more communication chips and/or chip sets, and so on. In a more particular example, communications systems 608 can include hardware, firmware, and/or software that can be used to establish a Wi-Fi connection, a Bluetooth connection, a cellular connection, an Ethernet connection, and so on.

In some embodiments, memory 610 can include any suitable storage device or devices that can be used to store instructions, values, data, or the like, that can be used, for example, by processor 602 to present content using display 604, to communicate with server 552 via communications system(s) 608, and so on. Memory 610 can include any suitable volatile memory, non-volatile memory, storage, or any suitable combination thereof. For example, memory 610 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 610 can have encoded thereon, or otherwise stored therein, a computer program for controlling operation of computing device 550. In such embodiments, processor 602 can execute at least a portion of the computer program to present content (e.g., images, user interfaces, graphics, tables), receive content from server 552, transmit information to server 552, and so on. For example, the processor 602 and the memory 610 can be configured to perform the methods described herein (e.g., the method of FIG. 1, the method of FIG. 3, the method of FIG. 4).

In some embodiments, server 552 can include a processor 612, a display 614, one or more inputs 616, one or more communications systems 618, and/or memory 620. In some embodiments, processor 612 can be any suitable hardware processor or combination of processors, such as a CPU, a GPU, and so on. In some embodiments, display 614 can include any suitable display devices, such as an LCD screen, LED display, OLED display, electrophoretic display, a computer monitor, a touchscreen, a television, and so on. In some embodiments, inputs 616 can include any suitable input devices and/or sensors that can be used to receive user input, such as a keyboard, a mouse, a touchscreen, a microphone, and so on.

In some embodiments, communications systems 618 can include any suitable hardware, firmware, and/or software for communicating information over communication network 554 and/or any other suitable communication networks. For example, communications systems 618 can include one or more transceivers, one or more communication chips and/or chip sets, and so on. In a more particular example, communications systems 618 can include hardware, firmware, and/or software that can be used to establish a Wi-Fi connection, a Bluetooth connection, a cellular connection, an Ethernet connection, and so on.

In some embodiments, memory 620 can include any suitable storage device or devices that can be used to store instructions, values, data, or the like, that can be used, for example, by processor 612 to present content using display 614, to communicate with one or more computing devices 550, and so on. Memory 620 can include any suitable volatile memory, non-volatile memory, storage, or any suitable combination thereof. For example, memory 620 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 620 can have encoded thereon a server program for controlling operation of server 552. In such embodiments, processor 612 can execute at least a portion of the server program to transmit information and/or content (e.g., data, images, a user interface) to one or more computing devices 550, receive information and/or content from one or more computing devices 550, receive instructions from one or more devices (e.g., a personal computer, a laptop computer, a tablet computer, a smartphone), and so on.

In some embodiments, the server 552 is configured to perform the methods described in the present disclosure. For example, the processor 612 and memory 620 can be configured to perform the methods described herein (e.g., the method of FIG. 1, the method of FIG. 3, the method of FIG. 4).

In some embodiments, data source 502 can include a processor 622, one or more data acquisition systems 624, one or more communications systems 626, and/or memory 628. In some embodiments, processor 622 can be any suitable hardware processor or combination of processors, such as a CPU, a GPU, and so on. In some embodiments, the one or more data acquisition systems 624 are generally configured to acquire data, images, or both, and can include an MRI system. Additionally or alternatively, in some embodiments, the one or more data acquisition systems 624 can include any suitable hardware, firmware, and/or software for coupling to and/or controlling operations of an MRI system. In some embodiments, one or more portions of the data acquisition system(s) 624 can be removable and/or replaceable.

Note that, although not shown, data source 502 can include any suitable inputs and/or outputs. For example, data source 502 can include input devices and/or sensors that can be used to receive user input, such as a keyboard, a mouse, a touchscreen, a microphone, a trackpad, a trackball, and so on. As another example, data source 502 can include any suitable display devices, such as an LCD screen, an LED display, an OLED display, an electrophoretic display, a computer monitor, a touchscreen, a television, etc., one or more speakers, and so on.

In some embodiments, communications systems 626 can include any suitable hardware, firmware, and/or software for communicating information to computing device 550 (and, in some embodiments, over communication network 554 and/or any other suitable communication networks). For example, communications systems 626 can include one or more transceivers, one or more communication chips and/or chip sets, and so on. In a more particular example, communications systems 626 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 628 can include any suitable storage device or devices that can be used to store instructions, values, data, or the like, that can be used, for example, by processor 622 to control the one or more data acquisition systems 624, and/or receive data from the one or more data acquisition systems 624; to generate images from data; present content (e.g., data, images, a user interface) using a display; communicate with one or more computing devices 550; and so on. Memory 628 can include any suitable volatile memory, non-volatile memory, storage, or any suitable combination thereof. For example, memory 628 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 628 can have encoded thereon, or otherwise stored therein, a program for controlling operation of data source 502. In such embodiments, processor 622 can execute at least a portion of the program to generate images, transmit information and/or content (e.g., data, images, a user interface) to one or more computing devices 550, receive information and/or content from one or more computing devices 550, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

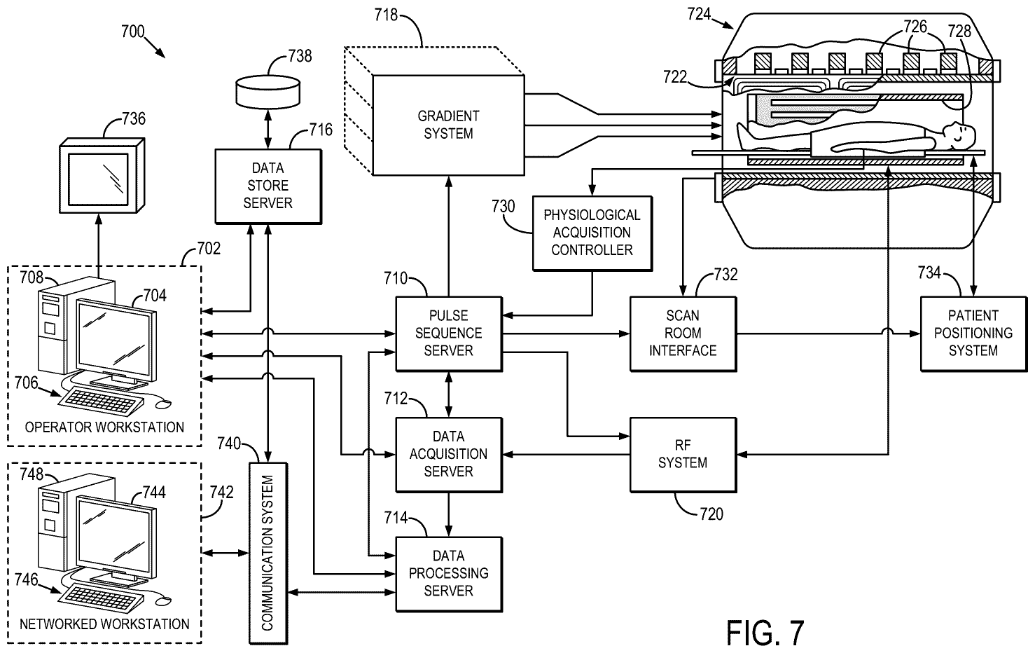

Referring particularly now to FIG. 7, an example of an MRI system 700 that can implement the methods described here is illustrated. The MRI system 700 includes an operator workstation 702 that may include a display 704, one or more input devices 706 (e.g., a keyboard, a mouse), and a processor 708. The processor 708 may include a commercially available programmable machine running a commercially available operating system. The operator workstation 702 provides an operator interface that facilitates entering scan parameters into the MRI system 700. The operator workstation 702 may be coupled to different servers, including, for example, a pulse sequence server 710, a data acquisition server 712, a data processing server 714, and a data store server 716. The operator workstation 702 and the servers 710, 712, 714, and 716 may be connected via a communication system 740, which may include wired or wireless network connections.

The pulse sequence server 710 functions in response to instructions provided by the operator workstation 702 to operate a gradient system 718 and a radiofrequency (“RF”) system 720. Gradient waveforms for performing a prescribed scan are produced and applied to the gradient system 718, which then excites gradient coils in an assembly 722 to produce the magnetic field gradients Gₓ, G_{y}, and G_{z} that are used for spatially encoding magnetic resonance signals. The gradient coil assembly 722 forms part of a magnet assembly 724 that includes a polarizing magnet 726 and a whole-body RF coil 728.

RF waveforms are applied by the RF system 720 to the RF coil 728, or a separate local coil to perform the prescribed magnetic resonance pulse sequence. Responsive magnetic resonance signals detected by the RF coil 728, or a separate local coil, are received by the RF system 720. The responsive magnetic resonance signals may be amplified, demodulated, filtered, and digitized under direction of commands produced by the pulse sequence server 710. The RF system 720 includes an RF transmitter for producing a wide variety of RF pulses used in MRI pulse sequences. The RF transmitter is responsive to the prescribed scan and direction from the pulse sequence server 710 to produce RF pulses of the desired frequency, phase, and pulse amplitude waveform. The generated RF pulses may be applied to the whole-body RF coil 728 or to one or more local coils or coil arrays.

The RF system 720 also includes one or more RF receiver channels. An RF receiver channel includes an RF preamplifier that amplifies the magnetic resonance signal received by the coil 728 to which it is connected, and a detector that detects and digitizes the I and Q quadrature components of the received magnetic resonance signal. The magnitude of the received magnetic resonance signal may, therefore, be determined at a sampled point by the square root of the sum of the squares of the I and Q components:

$$M = \sqrt{{I}^{2} + {Q}^{2}} ;$$

and the phase of the received magnetic resonance signal may also be determined according to the following relationship:

$$φ = {tan}^{- 1} ( \frac{Q}{I} ) .$$

The pulse sequence server 710 may receive patient data from a physiological acquisition controller 730. By way of example, the physiological acquisition controller 730 may receive signals from a number of different sensors connected to the patient, including electrocardiograph (“ECG”) signals from electrodes, or respiratory signals from a respiratory bellows or other respiratory monitoring devices. These signals may be used by the pulse sequence server 710 to synchronize, or “gate,” the performance of the scan with the subject's heart beat or respiration.

The pulse sequence server 710 may also connect to a scan room interface circuit 732 that receives signals from various sensors associated with the condition of the patient and the magnet system. Through the scan room interface circuit 732, a patient positioning system 734 can receive commands to move the patient to desired positions during the scan.

The digitized magnetic resonance signal samples produced by the RF system 720 are received by the data acquisition server 712. The data acquisition server 712 operates in response to instructions downloaded from the operator workstation 702 to receive the real-time magnetic resonance data and provide buffer storage, so that data is not lost by data overrun. In some scans, the data acquisition server 712 passes the acquired magnetic resonance data to the data processor server 714. In scans that require information derived from acquired magnetic resonance data to control the further performance of the scan, the data acquisition server 712 may be programmed to produce such information and convey it to the pulse sequence server 710. For example, during pre-scans, magnetic resonance data may be acquired and used to calibrate the pulse sequence performed by the pulse sequence server 710. As another example, navigator signals may be acquired and used to adjust the operating parameters of the RF system 720 or the gradient system 718, or to control the view order in which k-space is sampled. In still another example, the data acquisition server 712 may also process magnetic resonance signals used to detect the arrival of a contrast agent in a magnetic resonance angiography (“MRA”) scan. For example, the data acquisition server 712 may acquire magnetic resonance data and processes it in real-time to produce information that is used to control the scan.

The data processing server 714 receives magnetic resonance data from the data acquisition server 712 and processes the magnetic resonance data in accordance with instructions provided by the operator workstation 702. Such processing may include, for example, reconstructing two-dimensional or three-dimensional images by performing a Fourier transformation of raw k-space data, performing other image reconstruction algorithms (e.g., iterative or backprojection reconstruction algorithms), applying filters to raw k-space data or to reconstructed images, generating functional magnetic resonance images, or calculating motion or flow images.

Images reconstructed by the data processing server 714 are conveyed back to the operator workstation 702 for storage. Real-time images may be stored in a data base memory cache, from which they may be output to operator display 702 or a display 736. Batch mode images or selected real time images may be stored in a host database on disc storage 738. When such images have been reconstructed and transferred to storage, the data processing server 714 may notify the data store server 716 on the operator workstation 702. The operator workstation 702 may be used by an operator to archive the images, produce films, or send the images via a network to other facilities.

The MRI system 700 may also include one or more networked workstations 742. For example, a networked workstation 742 may include a display 744, one or more input devices 746 (e.g., a keyboard, a mouse), and a processor 748. The networked workstation 742 may be located within the same facility as the operator workstation 702, or in a different facility, such as a different healthcare institution or clinic.

The networked workstation 742 may gain remote access to the data processing server 714 or data store server 716 via the communication system 740. Accordingly, multiple networked workstations 742 may have access to the data processing server 714 and the data store server 716. In this manner, magnetic resonance data, reconstructed images, or other data may be exchanged between the data processing server 714 or the data store server 716 and the networked workstations 742, such that the data or images may be remotely processed by a networked workstation 742.

The present disclosure has described one or more preferred embodiments, and it should be appreciated that many equivalents, alternatives, variations, and modifications, aside from those expressly stated, are possible and within the scope of the invention.

1. A method for automated segmentation and analysis of an anatomy of interest from magnetic resonance image data, the method comprising:
accessing magnetic resonance image data with a computer system, wherein the magnetic resonance image data comprise magnetic resonance images acquired from a subject using a magnetic resonance imaging (MRI) system;
generating segmented anatomy volume data from the magnetic resonance image data using the computer system, wherein the segmented anatomy volume data comprise a three-dimensional (3D) volume of an anatomy of interest that is segmented from the magnetic resonance image data;
generating centerline tracking data from the segmented anatomy volume data using the computer system, wherein the centerline tracking data comprise a centerline of the 3D volume of the anatomy of interest;
generating, with the computer system, quantitative measures of the anatomy of interest based on the segmented anatomy volume data and the centerline tracking data; and
outputting at least one of the segmented anatomy volume data, the centerline tracking data, or the quantitative measures using the computer system.

2. The method of claim 1, wherein generating the segmented anatomy volume data comprises:
accessing a machine learning model with the computer system, wherein the machine learning model has been trained on training data to segment anatomy from magnetic resonance images; and
inputting the magnetic resonance image data to the machine learning model, generating the segmented anatomy volume data as an output.

3. The method of claim 2, wherein the machine learning model comprises a neural network implementing a U-Net architecture.

4. The method of claim 1, wherein generating the centerline tracking data comprises selecting a starting point in the segmented anatomy volume data and tracking a line from the starting point to a next point to define a line segment of the centerline.

5. The method of claim 4, wherein the starting point is automatically determined from the segmented anatomy volume data.

6. The method of claim 4, wherein the next point is determined by:
moving a predetermined distance along the segmented anatomy volume;
searching for an updated plane using a wobble function to apply inclination angles to the plane to find the updated plane as an angled plane with minimum cross-sectional area;
determining a center-of-mass of the updated plane; and
setting the center-of-mass of the updated plane as the next point.

7. The method of claim 1, wherein the quantitative measure comprises a maximum cross-sectional diameter of the 3D volume of the anatomy of interest measured from the centerline.

8. The method of claim 1, wherein the quantitative measure comprises a heat map that indicates regions where there are deformations in the anatomy of interest relative to normative measures.

9. The method of claim 8, wherein the heat map comprises a 3D heat map.

10. The method of claim 8, wherein the normative measures comprise measures from at least one of an age-matched cohort, a sex-matched cohort, a race-matched cohort, or a disease-matched cohort.

11. The method of claim 1, wherein the quantitative measures comprise a heat map that indicates regions where there are deformations in the anatomy of interest indicative of longitudinal changes in the subject measured relative to previously generated segmented anatomy volume data from the subject.

12. The method of claim 1, wherein the anatomy of interest is an aorta and the segmented anatomy volume data comprise a 3D model of an aortic arch of the aorta.

13. The method of claim 1, wherein outputting the at least one of the segmented anatomy volume data, the centerline tracking data, or the quantitative measures comprises overlaying the segmented anatomy volume data on the magnetic resonance image data and displaying the overlaid segmented anatomy volume data and magnetic resonance image data to a user using the computer system.

14. The method of claim 13, wherein the magnetic resonance images contained in the magnetic resonance image data comprise DICOM images and overlaying the segmented anatomy volume data on the magnetic resonance image data comprises converting the segmented anatomy volume data to a data structure that is compatible with the DICOM images.

15. The method of claim 1, wherein outputting the at least one of the segmented anatomy volume data, the centerline tracking data, or the quantitative measures comprises displaying at least one of the segmented anatomy volume data and the centerline tracking data in one of a virtual reality environment, an augmented reality environment, or an extended reality environment.

16. The method of claim 1, wherein the magnetic resonance image data comprise magnetic resonance images acquired from the subject without use of a contrast agent.

17. A method for analysis of a segmented anatomy of interest generated from magnetic resonance image data, the method comprising:
accessing segmented anatomy volume data with a computer system, wherein the segmented anatomy volume data comprise a segmented volume of an aortic arch of a subject;
generating a centerline tracking with the computer system by:
selecting a starting point in the segmented anatomy volume data;
iteratively tracking a line from the starting point to a series of next points to define a centerline of the segmented anatomy volume, wherein each given next point in the series of next points is determined by:
moving a predetermined distance along the segmented anatomy volume;
searching for an updated plane using a wobble function to apply inclination angles to the plane to find the updated plane as an angled plane with minimum cross-sectional area;
determining a center-of-mass of the updated plane;
setting the center-of-mass of the updated plane as the given next point;
generating, with the computer system, quantitative measures of the aortic arch based on the segmented anatomy volume data and the centerline tracking data; and
outputting the quantitative measures with the computer system.

18. The method of claim 17, further comprising computing quantitative measures of a geometry of the aortic arch from the segmented anatomy volume data and using the centerline tracking data.

19. The method of claim 18, wherein the quantitative measures of the geometry of the aortic arch comprise cross-section diameters of the aortic arch.

20. The method of claim 19, wherein the cross-section diameters of the aortic arch are generated at a number of predetermined clinical locations.

21. The method of claim 15, wherein the quantitative measures comprise a heat map that indicates regions where there are deformations in the aortic arch relative to normative measures.

22. The method of claim 21, wherein the normative measures comprise measures from at least one of an age-matched cohort, a sex-matched cohort, a race-matched cohort, or a disease-matched cohort.

23. The method of claim 15, wherein the quantitative measures comprise a heat map that indicates regions where there are deformations in the aortic arch indicative of longitudinal changes in the subject measured relative to previously generated segmented anatomy volume data from the subject.
